(19) United States
(12) Patent Application Publication
(10) Pub. No.: US 2025/0201905 A1
(43) Pub. Date: Jun. 19, 2025

(54) LITHIUM SECONDARY BATTERY, AND METHOD FOR PRODUCING LITHIUM SECONDARY BATTERY

(71) Applicants: TOYOTA JIDOSHA KABUSHIKI KAISHA, Toyota-shi Aichi-ken (JP); TOHOKU UNIVERSITY, Aoba-ku Sendai-shi Miyagi (JP)

(72) Inventors: Daisuke Horikawa, Toyota-shi Aichi-ken (JP); Hiroyuki Yamaguchi, Toyota-shi Aichi-ken (JP); Hiroshi Tsubouchi, Nagoya-shi Aichi-ken (JP); Tetsu Ichitsubo, Sendai-shi Miyagi-ken (JP); Hongyi Li, Sendai-shi Miyagi-ken (JP)

(73) Assignees: TOYOTA JIDOSHA KABUSHIKI KAISHA, Toyota-shi Aichi-ken (JP); TOHOKU UNIVERSITY, Aoba-ku Sendai-shi Miyagi (JP)

(21) Appl. No.: 18/982,416

(22) Filed: Dec. 16, 2024

(30) Foreign Application Priority Data
Dec. 18, 2023 (JP) 2023-213357

(51) Int. Cl. H01M 10/0525; H01M 4/02; H01M 4/04; H01M 4/38

(52) U.S. Cl. CPC H01M 10/0525; H01M 4/0404; H01M 4/0423; H01M 4/382; H01M 2004/027

(57) ABSTRACT

A lithium secondary battery includes a lithium metal and/or a lithium alloy as a negative electrode active material, in which the lithium secondary battery can be enhanced in capacity retention rate and can be suppressed in generation of dendrite lithium. A lithium secondary battery comprises a negative electrode current collector layer, a metal layer, and a negative electrode active material layer, the negative electrode active material layer contains a lithium metal or a lithium alloy, the coverage of the negative electrode current collector layer with the metal layer is 50% or more and less than 95%, and the metal layer has a first metal that is taken with lithium to form an alloy, and a second metal contained in the negative electrode current collector layer.

### CROSS-REFERENCE TO RELATED APPLICATIONS

This application claims priority to Japanese Patent Application No. 2023-213357 filed Dec. 18, 2023, the entire contents of which are herein incorporated by reference.

### FIELD

The present disclosure relates to a lithium secondary battery, and a method for producing a lithium secondary battery.

### BACKGROUND

Lithium secondary batteries with lithium metals and/or lithium alloys as negative electrode active materials are large in potential difference between negative electrodes and positive electrodes and achieve a high output voltage, and have a high theoretical capacity density and thus can be expected to be put into practical use, and the following lithium secondary battery is disclosed.

For example, PTL 1 discloses a lithium secondary battery utilizing a deposition-dissolution reaction of a lithium metal, as the reaction of a negative electrode, in which the negative electrode comprises a negative electrode layer, the negative electrode layer contains an alloy of the lithium metal and a dissimilar metal, as a negative electrode active material, and the element ratio of a lithium element in the alloy in full charge of the lithium secondary battery is 40.00 atomic % or more and 99.97 atomic % or less. According to PTL 1, there can be provided a lithium secondary battery which can be enhanced in capacity retention rate.

### CITATION LIST

### Patent Literature

[PTL 1] Japanese Unexamined Patent Publication (Kokai) No. 2023-103517

### SUMMARY

### Technical Problem

Lithium secondary batteries with lithium metals and/or lithium alloys as negative electrode active materials, while are expected to have desirable battery characteristics, are actually low in capacity retention rate, and have a risk of short-circuit due to generation of dendrite lithium. Therefore, such lithium secondary batteries have room for improvement in terms of capacity retention rate and suppression of dendrite lithium generation.

An object of the present disclosure is then to provide a lithium secondary battery with a lithium metal and/or a lithium alloy as a negative electrode active material, in which the lithium secondary battery can be enhanced in capacity retention rate and can be suppressed in generation of dendrite lithium.

### Solution to Problem

The present disclosure is to achieve the above object by the following measures.

### <Aspect 1>

A lithium secondary battery, wherein
the lithium secondary battery comprises a negative electrode current collector layer, a metal layer, a negative electrode active material layer, an electrolyte layer, a positive electrode active material layer, and a positive electrode current collector layer in the listed order,
the negative electrode active material layer contains a lithium metal or a lithium alloy,
the coverage of the negative electrode current collector layer with the metal layer is 50% or more and less than 95%, and
the metal layer has a first metal that is taken with lithium to form an alloy, and a second metal contained in the negative electrode current collector layer.

### <Aspect 2>

The lithium secondary battery according to Aspect 1, wherein the thickness of the metal layer is 10 nm to 4000 nm.

### <Aspect 3>

The lithium secondary battery according to Aspect 1 or 2, wherein the first metal is at least one selected from magnesium, aluminum, silicon, calcium, scandium, titanium, manganese, zinc, gallium, germanium, strontium, yttrium, zirconium, palladium, indium, tin, barium, and gold.

### <Aspect 4>

A method for producing the lithium secondary battery according to any one of Aspects 1 to 3, the method comprising the following steps of:
vapor-depositing the first metal and the second metal on a surface of the negative electrode current collector layer, thereby forming the metal layer, to obtain a preliminary negative electrode laminate,
stacking the preliminary negative electrode laminate, an electrolyte layer, a positive electrode active material layer that retains lithium, and a positive electrode current collector layer in the listed order, to obtain a preliminary lithium secondary battery, and
subjecting the preliminary lithium secondary battery to a charge operation, thereby depositing lithium transferred from the positive electrode active material layer, on a surface of the metal layer, to form the negative electrode active material layer and thus obtain the lithium secondary battery.

### Effects

According to the present disclosure, it is possible to allow a lithium secondary battery with a lithium metal and/or a lithium alloy as a negative electrode active material to be enhanced in capacity retention rate and suppressed in generation of dendrite lithium.

### BRIEF DESCRIPTION OF DRAWINGS

FIG. 1 is a schematic view for describing the negative electrode laminate layer and the metal layer of the lithium secondary battery of the present disclosure.

FIG. 2 is a schematic view for describing the lithium secondary battery of the present disclosure.

FIG. 3A is a schematic view for describing the method for producing the lithium secondary battery of the present disclosure.

FIG. 3B is a schematic view for describing the method for producing the lithium secondary battery of the present disclosure.

### DESCRIPTION OF EMBODIMENTS

Hereinafter, embodiments of the present disclosure are described in detail. Herein, the present disclosure is not limited to the following embodiments, and can be variously modified and carried out within the gist of the present disclosure. In the description of the drawings, the same symbol is applied to the same element, and the overlapped description is omitted.

In the present disclosure, the “mixture” means a composition which can directly form or further contain any other component to form a positive electrode active material layer or the like. In the present disclosure, the “mixture slurry” means a slurry which contains a dispersion medium in addition to the “mixture”, and thus can be applied and dried to form a positive electrode active material layer or the like.

The lithium secondary battery of the present disclosure may be a liquid-based battery containing an electrolytic solution as an electrolyte layer, or may be a solid-state battery comprising a solid electrolyte layer as an electrolyte layer. In the present disclosure, the “solid-state battery” means a battery with at least a solid electrolyte as an electrolyte, and therefore a combination of a solid electrolyte and a liquid electrolyte may be used as an electrolyte in the solid-state battery. The lithium secondary battery of the present disclosure may be an all-solid-state battery, namely, a battery with only a solid electrolyte as an electrolyte.

### <<Lithium Secondary Battery>>

The lithium secondary battery of the present disclosure comprises
a negative electrode current collector layer, a metal layer, a negative electrode active material layer, an electrolyte layer, a positive electrode active material layer, and a positive electrode current collector layer in the listed order,
the negative electrode active material layer contains a lithium metal or a lithium alloy,
the coverage of the negative electrode current collector layer with the metal layer is 50% or more and less than 95%, and
the metal layer has a first metal that is taken with lithium to form an alloy, and a second metal contained in the negative electrode current collector layer.

According to the present disclosure, it is possible to allow a lithium secondary battery with a lithium metal and/or a lithium alloy as a negative electrode active material to be enhanced in capacity retention rate and suppressed in generation of dendrite lithium.

Without being limited by theory, it is presumed that a metal layer 112 having a predetermined coverage promotes lithium nucleation to enable generation of lithium dendrite to be suppressed. In addition, a metal layer 112 serving as resistance does not cover the entire surface of a negative electrode current collector layer, and therefore, it is presumed that a favorable electron conductivity can be kept to result in an increase in capacity retention rate. In particular, it is presumed that, in the case of a liquid-based battery, a reaction-active point of lithium is generated at a three phase interface among a section not covered with any metal layer, a metal layer and an electrolytic solution and lithium located closer to the electrolytic solution is attracted to decrease the resistance value, resulting in an increase in capacity retention rate.

FIG. 2 is a schematic view illustrating one aspect of the lithium secondary battery of the present disclosure, but not limited to such a case.

A lithium secondary battery 100 comprises a negative electrode laminate 110, a negative electrode current collector layer 111, a metal layer 112, a negative electrode active material layer 113, an electrolyte layer 120, a positive electrode laminate 130, a positive electrode active material layer 131, and a positive electrode current collector layer 132 in the listed order, and the negative electrode current collector layer 111 is covered with the metal layer 112 at a predetermined coverage. The metal layer 112, which has a predetermined coverage, can enhance the capacity retention rate of the lithium secondary battery and can suppress generation of dendrite lithium. It is presumed that the metal layer 112, which has a predetermined coverage, promotes lithium nucleation to enable generation of lithium dendrite to be suppressed. In addition, the metal layer 112, which serves as resistance, does not cover the entire surface of the negative electrode current collector layer 111, and therefore, it is presumed that a favorable electron conductivity can be kept to result in an increase in capacity retention rate.

<Configuration of lithium secondary battery>

The lithium secondary battery of the present disclosure comprises a negative electrode current collector layer, a metal layer, a negative electrode active material layer, an electrolyte layer, a positive electrode active material layer, and a positive electrode current collector layer in the listed order.

### <Negative Electrode Current Collector Layer>

The material used in the negative electrode current collector layer is not particularly limited, and a common negative electrode current collector for lithium secondary batteries can be appropriately selected. Examples of the material used in the negative electrode current collector layer can include Cu, Ni, Cr, Au, Pt, Ag, Al, Fe, Ti, Zn, Co, stainless steel, or a carbon sheet, but not limited to such a case. In particular, the material used in the negative electrode current collector layer may be one containing at least one selected from Cu, Ni and stainless steel or may be one made of a carbon sheet, for example, from the viewpoint of ensuring the reduction resistance and from the viewpoint of hardly alloying with lithium. The negative electrode current collector layer may have any coat layer on the surface thereof for the purpose of, for example, adjustment of the resistance.

The shape of the negative electrode current collector layer is not particularly limited, and examples can include a foil shape, a plate shape, or a mesh shape. In particular, a foil shape may be selected.

The thickness of the negative electrode current collector layer is not particularly limited, and may be 0.1 μm or more, or 1 μm or more, and may be 1 mm or less, or 100 μm or less.

### <Metal Layer>

In the lithium secondary battery of the present disclosure, the metal layer has a first metal that is taken with lithium to form an alloy, and a second metal contained in the negative electrode current collector layer. Here, the first metal and the second metal may or may not be a combination for formation of an alloy.

### (First Metal)

The first metal is not particularly limited as long as it is one that is taken with lithium to form an alloy.

The first metal is not particularly limited, and may be at least one selected from magnesium, aluminum, silicon, calcium, scandium, titanium, manganese, zinc, gallium, germanium, strontium, yttrium, zirconium, palladium, indium, tin, barium, and gold.

### (Second Metal)

The second metal is not particularly limited as long as it is a metal contained in the negative electrode current collector layer. For example, in a case where copper is used in the negative electrode current collector layer, the second metal is copper.

The material used in the negative electrode current collector layer, namely, the metal contained in the negative electrode current collector layer can be determined with reference to the description of “<Negative electrode current collector layer>” above.

### (Coverage of Metal Layer)

In the lithium secondary battery of the present disclosure, the coverage of the negative electrode current collector layer with the metal layer is 50% or more and less than 95%. The coverage is not particularly limited, and may be 50% or more, 60% or more, or 70% or more, and may be less than 95%, 90% or less, or 80% or less from the viewpoint of the capacity retention rate and suppression of dendrite lithium generation.

The metal layer is not particularly limited, and the negative electrode current collector layer can be covered therewith at a predetermined coverage by film-forming into any shape such as a shape of a plurality of dots, circles, ellipses, rectangles, or polygons. The area of each section where the metal layer is film-formed is not particularly limited.

The metal layer is not particularly limited, and can be formed by film-forming the first metal and the second metal by a vapor-deposition system. A metal layer having a predetermined coverage can be formed by using, for example, a metal mask having predetermined opening ratio and opening shape, during the film-forming. The coverage can be controlled by, for example, the opening ratio of the metal mask.

The thickness of the metal layer is not particularly limited, and may be 10 nm to 4000 nm. The thickness of the metal layer, for example, may be 10 nm or more, 100 nm or more, 200 nm or more, or 500 nm or more, and may be 4000 nm or less, 2000 nm or less, or 1000 nm or less. The thickness of the metal layer can be measured by observation of a cross section of the metal layer with a scanning electron microscope (SEM).

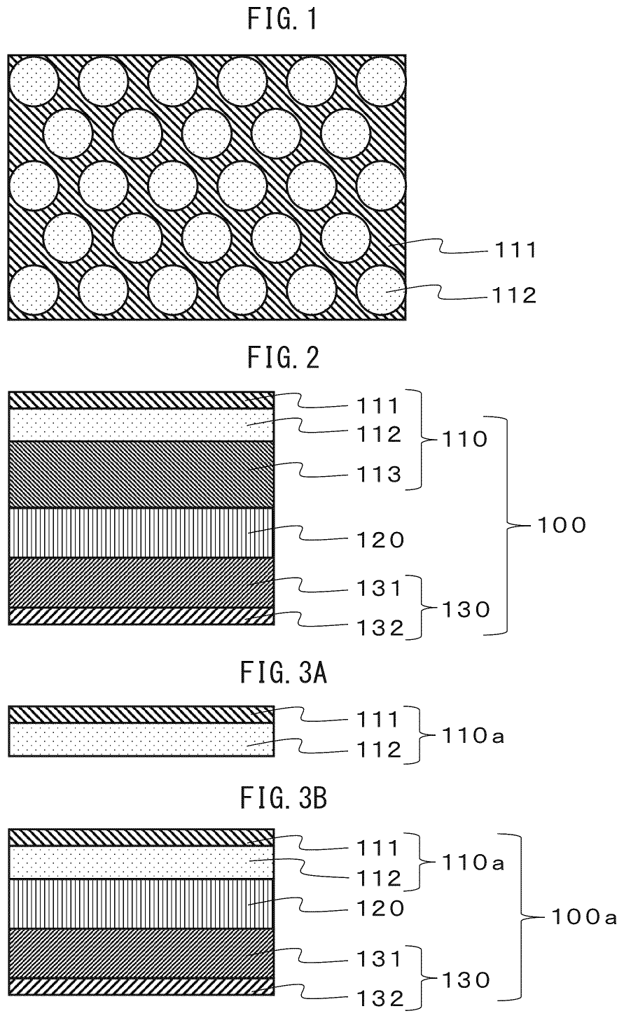

FIG. 1 is a schematic view of one aspect of the negative electrode current collector layer and the metal layer with which the negative electrode current collector layer is covered, in the lithium secondary battery of the present disclosure, but not limited to such a case.

A metal layer 112 of a plurality of circles is film-formed on a surface of a negative electrode current collector layer 111. The negative electrode current collector layer 111 is covered at a predetermined coverage with the metal layer 112 film-formed into a plurality of circles.

### <Negative Electrode Active Material Layer>

In the lithium secondary battery of the present disclosure, the negative electrode active material layer contains a lithium metal or a lithium alloy.

In a case where the “negative electrode active material layer” contains a lithium metal, a layer of the lithium metal as the “negative electrode active material layer” is present in a charge state, whereas the lithium metal is moved as a lithium ion to the positive electrode active material layer and no layer of the lithium metal as the “negative electrode active material layer” may be present in a discharge state. Similarly, in a case where the “negative electrode active material layer” contains a lithium alloy, a layer of the lithium alloy as the “negative electrode active material layer” is present in a charge state, whereas lithium of the lithium alloy is moved as a lithium ion to the positive electrode active material layer and no layer of the lithium alloy as the “negative electrode active material layer” may be present and a layer of a metal due to removal of lithium from the lithium alloy may be present in a discharge state.

The negative electrode active material layer contains at least a lithium metal or a lithium alloy as a negative electrode active material, and may further optionally contain a conductive aid, a binder, a solid electrolyte, and the like. The negative electrode active material layer may contain various other additives. The content of each of the negative electrode active material, the conductive aid, the binder, the solid electrolyte, and the like in the negative electrode active material layer may be appropriately determined depending on the objective battery performance. For example, when the total (total solid content) of the negative electrode active material layer is assumed to be 100% by mass, the content of the negative electrode active material may be 40% by mass or more, 50% by mass or more, 60% by mass or more, and may be 100% by mass or less, or 90% by mass or less.

### (Negative Electrode Active Material)

The negative electrode active material here used is at least a lithium metal or a lithium alloy, as described above. The lithium alloy is not particularly limited, may be a material which is to be alloyed with lithium and can occlude and release a lithium ion, and examples include a silicon alloy-based negative electrode active material and a tin alloy-based active material, but not limited to these cases. The silicon alloy-based negative electrode active material is, for example, silicon, silicon oxide, silicon carbide, silicon nitride, or a solid solution thereof. The silicon alloy-based negative electrode active material can contain any other metal element than silicon, for example, Fe, Co, Sb, Bi, Pb, Ni, Cu, Zn, Ge, In, Sn, and/or Ti. The tin alloy-based negative electrode active material is, for example, tin, tin oxide, tin nitride, or a solid solution thereof. The tin alloy-based negative electrode active material can contain any other metal element than tin, for example, Fe, Co, Sb, Bi, Pb, Ni, Cu, Zn, Ge, In, Ti, and/or Si.

The negative electrode active material layer may contain any other negative electrode active material than the lithium metal or the lithium alloy. Such any other negative electrode active material than the lithium metal or the lithium alloy is not particularly limited, and examples include a carbon material. Examples of the carbon material include hard carbon, soft carbon, and graphite, but not limited to these cases.

The proportion of the lithium metal or the lithium alloy contained in the negative electrode active material layer is not particularly limited, and may be 50% by mass to 100% by mass, 60% by mass to 100% by mass, 70% by mass to 100% by mass, 80% by mass to 100% by mass, or 90% by mass to 100% by mass relative to the negative electrode active material layer.

### (Binder)

The binder is not particularly limited. The binder may be, for example, a material such as polyvinylidene fluoride (PVdF), butadiene rubber (BR), polytetrafluoroethylene (PTFE), or styrene-butadiene rubber (SBR), but not limited thereto. The binder is not particularly limited, and may be used singly or in combination of two or more kinds thereof.

### (Conductive Aid)

The conductive aid is not particularly limited. The conductive aid may be, for example, a vapor-grown carbon fiber (VGCF), acetylene black (AB), Ketjen black (KB), a carbon nanotube (CNT), or a carbon nanofiber (CNF), but not limited thereto. The conductive aid may be, for example, particulate or fibrous, and the size thereof is not particularly limited. The conductive aid is not particularly limited, and may be used singly or in combination of two or more kinds thereof.

### (Solid Electrolyte)

The material of the solid electrolyte is not particularly limited, and may be, for example, a sulfide solid electrolyte, an oxide solid electrolyte, or a polymer electrolyte.

Examples of the sulfide solid electrolyte include a sulfide-based amorphous solid electrolyte, a sulfide-based crystalline solid electrolyte, or an argyrodite-type solid electrolyte, but not limited thereto. Specific examples of the sulfide solid electrolyte can include Li₂S—P₂S₅-based solid electrolyte (Li₇P₃S₁₁, Li₃PS₄, Li₈P₂S₉, or the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, or the like), LiI—Li₂S—P₂O₅, LiI—Li₃PO₄—P₂S₅, or Li₇₋ₓPS₆₋ₓClₓ; or any combination thereof, but not limited thereto.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON), but not limited thereto.

The sulfide solid electrolyte and the oxide solid electrolyte may be each glass or crystallized glass (glass ceramics).

Examples of the polymer electrolyte include polyethylene oxide (PEO), polypropylene oxide (PPO), and any copolymer thereof, but not limited thereto.

The shape of the negative electrode active material is not particularly limited, and may be a shape common to negative electrode active materials for lithium secondary batteries. The negative electrode active material may have, for example, a layer shape or a sheet shape. The negative electrode active material may undergo deposition of lithium during charge, and/or may undergo dissolution of lithium during discharge. In this case, the negative electrode active material layer may be a layer composed of the lithium metal or the lithium alloy.

The shape of the negative electrode active material layer is not particularly limited, and may be, for example, a sheet-shaped negative electrode active material layer having a substantially flat surface. The thickness of the negative electrode active material layer is not particularly limited, and, for example, may be 0.1 μm or more, 1 μm or more, or 10 μm or more, and may be 200 μm or less, 1150 μm or less, or 100 μm or less.

The negative electrode active material layer can be formed with reference to the description of “<<Method for producing lithium secondary battery>>” below.

### <Electrolyte Layer>

### <Electrolyte Layer-Solid Electrolyte Layer>

The lithium secondary battery of the present disclosure can be a solid-state battery, namely, can have a solid electrolyte layer as the electrolyte layer.

The solid electrolyte layer may contain, if necessary, for example, a binder, in addition to the solid electrolyte.

The solid electrolyte and the binder can be determined with reference to the description of “<Negative electrode active material layer>”.

The thickness of the solid electrolyte layer is not particularly limited, and, for example, may be 0.1 μm or more, 1 μm or more, or 10 μm or more, and may be 2 mm or less, 1 mm or less, or 500 μm or less.

The solid electrolyte layer can be easily formed by, for example, dry or wet molding of an electrolyte mixture containing, for example, the above solid electrolyte and binder.

### <Electrolyte Layer-Separator Layer>

The lithium secondary battery of the present disclosure can be a liquid-based battery, namely, can have an electrolytic solution as the electrolyte layer, in particular, an electrolytic solution retained in a separator layer.

### (Electrolytic Solution)

The electrolytic solution is not particularly limited, and, in some embodiments, contains a supporting salt and a solvent.

The supporting salt (lithium salt) of an electrolytic solution having lithium ion conductivity is not particularly limited, and examples include an inorganic lithium salt and an organic lithium salt. Examples of the inorganic lithium salt include LiPF₆, LiBF₄, LiClO₄, or LiAsF₆, but not limited to these cases. Examples of the organic lithium salt include LiCF₃SO₃, LIN(CF₃SO₂)₂, LiN(C₂F₅SO₂)₂, LIN(FSO₂)₂, or LiC(CF₃SO₂)₃, but not limited to these cases.

The solvent used in the electrolytic solution is not particularly limited, and examples can include cyclic carbonate or linear carbonate. Examples of the cyclic carbonate can include ethylene carbonate (EC), propylene carbonate (PC), or butylene carbonate (BC), but not limited to such a case. Examples of the linear carbonate include dimethyl carbonate (DMC), diethyl carbonate (DEC), or ethyl methyl carbonate (EMC), but not limited to such a case. The electrolytic solution is not particularly limited, and may be used singly or in combination of two or more kinds thereof.

### (Separator)

The separator is not particularly limited, and a common separator for lithium secondary batteries can be appropriately selected. The separator here used can be, for example, a polyolefin-based, polyamide-based, or polyimide-based non-woven fabric.

### <Positive Electrode Active Material Layer>

The positive electrode active material layer contains at least a positive electrode active material, and may further optionally contain a conductive aid, a solid electrolyte, a binder, and the like. The positive electrode active material layer may contain various other additives. The content of each of the positive electrode active material, the conductive aid, the binder, and the like in the positive electrode active material layer may be appropriately determined depending on the objective battery performance. For example, when the total (total solid content) of the positive electrode active material layer is assumed to be 100% by mass, the content of the positive electrode active material may be 40% by mass or more, 50% by mass or more, 60% by mass or more, and may be 100% by mass or less, or 90% by mass or less.

### (Positive Electrode Active Material)

The material of the positive electrode active material is not particularly limited as long as it can occlude and release a lithium ion. The positive electrode active material may be, for example, lithium cobaltate (LiCoO₂), lithium nickelate (LiNiO₂), lithium manganate (LiMn₂O₄), lithium nickelate/cobaltate/manganate (NCM), LiCO_{1/3}Ni_{1/3}Mn_{1/3}O₂, lithium nickelate/cobaltate/aluminate (NCA; LiNiₓCo_{y}Al_{z}O₂), or Li—Mn spinel having a composition represented by Li₁₊ₓMn_{2-x-y}M_{y}O₄ (M is one or more metal elements selected from Al, Mg, Co, Fe, Ni, and Zn) by substitution with a dissimilar element, but not limited thereto.

The positive electrode active material is not particularly limited, and may have a covering layer. The covering layer is a layer containing a substance which has lithium ion conductive performance, which is low in reactivity with the positive electrode active material and the solid electrolyte, and which does not flow even if contacted with the active material or the solid electrolyte and then can allow the form of the covering layer to be kept. Specific examples of the material constituting the covering layer can include Li₄Ti₅O₁₂ or Li₃PO₄, in addition to LiNbO₃, but not limited thereto.

The shape of the positive electrode active material is not particularly limited as long as it is a shape common to positive electrode active materials for lithium secondary batteries. The positive electrode active material may be, for example, particulate. The positive electrode active material may be a primary particle, or may be a secondary particle of a plurality of primary particles aggregated. The average particle size D₅₀ of the positive electrode active material, for example, may be 1 nm or more, 5 nm or more, or 10 nm or more, and may be 500 μm or less, 100 μm or less, 50 μm or less, or 30 μm or less. The average particle size D₅₀ is here a particle size (median size) at which the cumulative value in a particle size distribution on a volume basis, determined by a laser diffraction/scattering method, is 50%.

The solid electrolyte, the binder, and the conductive aid can be determined with reference to the description of “<Negative electrode active material layer>”.

The shape of the positive electrode active material layer is not particularly limited, and may be, for example, a sheet-shaped positive electrode active material layer having a substantially flat surface. The thickness of the positive electrode active material layer is not particularly limited, and, for example, may be 0.1 μm or more, 1 μm or more, or 10 μm or more, and may be 2 mm or less, 1 mm or less, or 500 μm or less.

### <Positive Electrode Current Collector Layer>

The material used in the positive electrode current collector layer is not particularly limited, and a common positive electrode current collector for lithium secondary batteries can be appropriately selected. Examples of the material used in the positive electrode current collector layer can include Cu, Ni, Cr, Au, Pt, Ag, Al, Fe, Ti, Zn, Co, or stainless steel, but not limited to such a case. The positive electrode current collector layer may have any coat layer on the surface thereof for the purpose of, for example, adjustment of the resistance. The positive electrode current collector layer may be a metal foil or substrate on which the above metal is plated or vapor-deposited.

The shape of the positive electrode current collector layer is not particularly limited, and examples can include a foil shape, a plate shape, or a mesh shape. In particular, a foil shape may be selected.

The thickness of the positive electrode current collector layer is not particularly limited, and may be 0.1 μm or more, or 1 μm or more, and may be 1 mm or less, or 100 μm or less.

The positive electrode active material layer can be produced by applying a known method. For example, the positive electrode active material layer can be easily formed by dry or wet molding of a positive electrode mixture containing various components described above. The positive electrode active material layer may be formed together with the positive electrode current collector layer, or may be formed separately from the positive electrode current collector layer.

### <Shape and the Like of Lithium Secondary Battery>

Examples of the shape of the lithium secondary battery include a coin shape, a laminate shape (pouch battery), a cylindrical shape, or a square shape, but not limited to these cases.

### <<Method for Producing Lithium Secondary Battery>>

The lithium secondary battery of the present disclosure can be produced by a production method comprising the following steps:
vapor-depositing the first metal and the second metal on a surface of the negative electrode current collector layer, thereby forming the metal layer, to obtain a preliminary negative electrode laminate,
stacking the preliminary negative electrode laminate, an electrolyte layer, a positive electrode active material layer that retains lithium, and a positive electrode current collector layer in the listed order, to obtain a preliminary lithium secondary battery, and
subjecting the preliminary lithium secondary battery to a charge operation, thereby depositing lithium transferred from the positive electrode active material layer, on a surface of the metal layer, to form the negative electrode active material layer and thus obtain the lithium secondary battery.

According to the method for producing the lithium secondary battery of the present disclosure, it is possible to produce a lithium secondary battery with a lithium metal and/or a lithium alloy as a negative electrode active material, in which the lithium secondary battery is enhanced in capacity retention rate.

FIGS. 3A and 3B are schematic views illustrating one aspect of the method for producing the lithium secondary battery of the present disclosure, but not limited to such a case. The method for producing the lithium secondary battery of the present disclosure is described with FIG. 2 and FIGS. 3A and 3B.

First, the first metal and the second metal are film-formed on a surface of a negative electrode current collector layer 111 by a vapor-deposition system with a metal mask having predetermined opening ratio and opening shape being interposed, thereby forming a metal layer 112 having a predetermined coverage, to form a preliminary negative electrode laminate 110a (FIG. 3A). Next, a positive electrode mixture is applied onto a positive electrode current collector layer 132 in a wet or dry manner, thereby forming a positive electrode active material layer 131, to form a positive electrode laminate 130, and the preliminary negative electrode laminate 110a, an electrolyte layer 120, and the positive electrode laminate 130 are stacked, thereby forming a preliminary lithium secondary battery 100a comprising the negative electrode current collector layer 111, the metal layer 112, the electrolyte layer 120, the positive electrode active material layer 131, and the positive electrode current collector layer 132 in the listed order (FIG. 3B). The preliminary lithium secondary battery 100a can be subjected to a charge operation, thereby depositing lithium transferred from the positive electrode active material layer, on a surface of the metal layer 112, to form a negative electrode active material layer 113 and thus form a lithium secondary battery 100 (FIG. 2).

### <Formation of Preliminary Negative Electrode Laminate>

The preliminary negative electrode laminate can be formed by vapor-depositing the first metal and the second metal on a surface of the negative electrode current collector layer, thereby forming a metal layer.

### (Preliminary Negative Electrode Laminate)

The preliminary negative electrode laminate is not particularly limited, and is a laminate where the negative electrode current collector and a metal layer are stacked in the listed order.

### (Formation of Metal Layer)

The metal layer is not particularly limited, and can be formed by film-forming the first metal and the second metal on a surface of the negative electrode current collector layer by a vapor-deposition system. A metal layer having a predetermined coverage can be formed by using, for example, a metal mask having predetermined opening ratio and opening shape, during the film-forming. The coverage can be controlled by, for example, the opening ratio of the metal mask.

### <Formation of Preliminary Lithium Secondary Battery>

The preliminary lithium secondary battery can be formed by stacking the preliminary negative electrode laminate, the electrolyte layer, a positive electrode active material layer that retains lithium, and the positive electrode current collector layer in the listed order.

### (Preliminary Lithium Secondary Battery)

The preliminary lithium secondary battery is not particularly limited, and is a laminate where the preliminary negative electrode laminate, the electrolyte layer, the positive electrode active material layer, and the positive electrode current collector layer are stacked in the listed order, namely, a laminate where the negative electrode current collector, the metal layer, the electrolyte layer, the positive electrode active material layer, and the positive electrode current collector layer are stacked in the listed order.

### <Formation of Lithium Secondary Battery>

The lithium secondary battery can be formed by subjecting the preliminary lithium secondary battery to a charge operation, thereby depositing lithium transferred from the positive electrode active material layer, on a surface of the metal layer, to form the negative electrode active material layer.

### (Charge Operation)

The charge operation can be performed, for example, in a cut-off voltage range of 3.3 to 4.2 V under a constant current condition. The amount of current (C rate) in the charge operation is not particularly limited, and may be 0.01 C or more, 0.1 C or more, 0.5 C or more, or 1.0 C or more, and may be 2.0 C or less, 1.5 C or less, 1.2 C or less, or 1.0 C or less.

(Formation of negative electrode active material layer)

The negative electrode active material layer is not particularly limited, and the negative electrode active material layer can be formed by subjecting the preliminary lithium secondary battery to the charge operation, to release lithium from a positive electrode active material that retains lithium, and deposit the lithium on the metal layer.

### EXAMPLES

The present disclosure is described in further detail with reference to Examples shown below, but the scope of the present disclosure is not limited to these Examples.

### Example 1

### <Production of Preliminary Negative Electrode Laminate: Formation of Metal Layer on Negative Electrode Current Collector Layer>

A preliminary negative electrode laminate was produced by film-forming tin (Sn) as a first metal and Cu as a second metal on one surface of copper (Cu) foil as a negative electrode current collector layer, by a vapor-deposition system (co-vapor deposition) to form a metal layer on the negative electrode current collector layer. When the film-forming was here made by a vapor-deposition system (co-vapor deposition), the metal layer was film-formed with a metal mask having an opening ratio of 50% and having an opening shape of a plurality of circles, and the film-forming was made so that the coverage of the negative electrode current collector layer with the metal layer was 50%. The film-forming was here made so that the thickness of the metal layer was 600 nm.

### <Production of Positive Electrode Laminate>

A positive electrode mixture slurry was prepared by mixing LiNi_{1/3}Co_{1/3}Mn_{1/3}O₂ (84 parts by mass) as a positive electrode active material, acetylene black (12 parts by mass) as a conductive aid, PVdF (4 parts by mass) as a binder, and a moderate amount of N-methyl-2-pyrrolidone (NMP) as a dispersion medium. Next, the resulting positive electrode mixture slurry was applied onto aluminum (Al) foil as a positive electrode current collector, and dried, thereby producing a positive electrode laminate in which a positive electrode active material layer was formed on a positive electrode current collector layer.

### <Production of Preliminary Lithium Secondary Battery>

The preliminary negative electrode laminate and the positive electrode laminate were stacked so as to be opposite with a polyolefin film (film thickness 20 μm) as a separator being interposed therebetween, and wound in a spiral manner. Respective terminals were connected to the preliminary negative electrode laminate and the positive electrode laminate wound, and were received in a battery case, 1 M LiPF₆ ethylene carbonate/dimethyl carbonate (1/1 (volume ratio)) as an electrolytic solution was injected thereinto, and the battery case was sealed, to produce a preliminary lithium secondary battery.

### <Formation of Lithium Secondary Battery and Evaluation of Capacity Retention Rate Thereof>

The preliminary lithium secondary battery was charged and discharged for 200 cycles with a constant-current (current rate 1 C) system in a cut-off voltage range of 3.3 to 4.2 V at 25° C. The capacity was measured at the first cycle and the 200-th cycle, and the capacity retention rate (Capacity retention rate=(Capacity at 200-th cycle)/(Capacity at first cycle)×100) was calculated. Table 1 shows the results of the capacity retention rate. The capacity retention rate in Table 1 is a relative value in a case where the capacity retention rate of the lithium secondary battery in Comparative Example 1 is 1.00. The preliminary lithium secondary battery was here subjected to a charge operation, thereby depositing lithium transferred from the positive electrode active material layer, on the metal layer, to form a lithium metal layer as a negative electrode active material layer and thus form a lithium secondary battery.

### <Evaluation of Short-Circuit Current of Lithium Secondary Battery>

The lithium secondary battery was charged at a constant current (current rate 1/3C) with the upper limit charge voltage as 3.5 V, and paused for 10 minutes, and the voltage was increased to 4.5 V. Next, the lithium secondary battery was paused for 10 minutes from the time of point where the voltage was increased to 4.5 V, and the cumulative value of the amount of current flowing during the pausing was determined. Table 1 shows the results of the short-circuit current. The short-circuit current in Table 1 is a relative value in a case where the short-circuit current of the lithium secondary battery in Comparative Example 1 is 1.00.

<Evaluation of Discharged Capacity after Vibration Duration of Lithium Secondary Battery>

The lithium secondary battery was charged to 4.2 V at a constant current (current rate 1 C). Next, the lithium secondary battery charged was secured to a horizontal/vertical vibration tester, and a load at a rate of acceleration of 20 G and a vibrational frequency of 45 Hz or less was applied thereto in each of the x, y, and z directions for 1000000 times. Thereafter, the lithium secondary battery to which the load was applied was discharged to 3.0 V at a constant current (current rate 1 C), and the discharged capacity was determined. Table 1 shows the results of the discharged capacity after the duration test. The discharged capacity after the duration test in Table 1 is a relative value in a case where the discharged capacity after the duration test of the lithium secondary battery in Comparative Example 1 is 1.00.

### Comparative Example 1

### <Production of Preliminary Negative Electrode Laminate>

No metal layer was formed on a negative electrode current collector layer and Cu foil as a negative electrode current collector was adopted as a preliminary negative electrode laminate.

<Production of Lithium Secondary Battery, Evaluation of Capacity Retention Rate Thereof, Evaluation of Short-Circuit Current Thereof, and Evaluation of Discharged Capacity after Vibration Duration Thereof>

A lithium secondary battery was produced with Cu foil with no metal layer formed thereon, by the same method as in Example 1. The capacity retention rate, the short-circuit current, and the discharged capacity after the duration test of the lithium secondary battery were evaluated by the same methods as in Example 1. In Examples and Comparative Examples herein, each relative value is shown in a case where the capacity retention rate and the discharged capacity after the duration test of the lithium metal secondary battery in Comparative Example 1 are each 1.00.

### Examples 2 to 4 and Comparative Examples 2 to 4 (Influence of Coverage of Negative Electrode Current Collector Layer with Metal Layer)

### <Production of Preliminary Negative Electrode Laminate: Formation of Metal Layer on Negative Electrode Current Collector Layer>

Each preliminary negative electrode laminate was produced by the same method as in Example 1 except that the coverage of the negative electrode current collector layer with the metal layer was each coverage described in Table 1, by use of a predetermined metal mask.

<Production of Lithium Secondary Battery, Evaluation of Capacity Retention Rate Thereof, Evaluation of Short-Circuit Current Thereof, and Evaluation of Discharged Capacity after Vibration Duration Thereof>

A lithium secondary battery was produced with the preliminary negative electrode laminate produced in each of Examples 2 to 4 and Comparative Examples 2 to 4, by the same method as in Example 1. The capacity retention rate, the short-circuit current, and the discharged capacity after the duration test of the lithium secondary battery in each of Examples 2 to 4 and Comparative Examples 2 to 4 were evaluated by the same methods as in Example 1. The respective results were as shown in Table 1.

TABLE 1

| | | | | | | Evaluation results | | |
|---|---|---|---|---|---|---|---|---|
| | | | | | | | | Discharged |
| | Negative | | | | | Capacity | | capacity |
| | electrode current | Metal layer | | | | retention | Short-circuit | after vibration |
| | collector layer | | | Thickness | Coverage | rate relative | current relative | duration relative |
| | Material of | | | of metal | with metal | to Comparative | to Comparative | to Comparative |
| | negative electrode | First | Second | layer | layer | Example 1 | Example 1 | Example 1 |
| | current collector | metal | metal | [nm] | [%] | [—] | [—] | [—] |
| Comparative | Copper (Cu) | — | — | — | — | 1.00 | 1.00 | 1.00 |
| Example 1 | | | | | | | | |
| Comparative | Copper (Cu) | Tin | Copper | 600 | 40 | 1.56 | 0.71 | 2.35 |
| Example 2 | | (Sn) | (Cu) | | | | | |
| Example 1 | Copper (Cu) | Tin | Copper | 600 | 50 | 2.12 | 0.33 | 3.01 |
| | | (Sn) | (Cu) | | | | | |
| Example 2 | Copper (Cu) | Tin | Copper | 600 | 60 | 2.22 | 0.43 | 3.52 |
| | | (Sn) | (Cu) | | | | | |
| Example 3 | Copper (Cu) | Tin | Copper | 600 | 70 | 2.05 | 0.42 | 3.43 |
| | | (Sn) | (Cu) | | | | | |
| Example 4 | Copper (Cu) | Tin | Copper | 600 | 80 | 2.02 | 0.43 | 3.44 |
| | | (Sn) | (Cu) | | | | | |
| Comparative | Copper (Cu) | Tin | Copper | 600 | 95 | 1.56 | 0.69 | 2.27 |
| Example 3 | | (Sn) | (Cu) | | | | | |
| Comparative | Copper (Cu) | Tin | Copper | 600 | 100 | 1.56 | 0.61 | 2.29 |
| Example 4 | | (Sn) | (Cu) | | | | | |

In a case where the coverage of the negative electrode current collector layer with the metal layer was 50% or more and less than 95%, the lithium secondary battery comprising the metal layer was increased in capacity retention rate and decreased in short-circuit current as compared with the lithium secondary battery comprising no metal layer. In addition, the lithium secondary battery comprising the metal layer was increased in discharged capacity after vibration duration. The short-circuit current was decreased, and it was thus indicated that generation of dendrite lithium was suppressed. On the other hand, in a case where the coverage of the negative electrode current collector layer with the metal layer was 100%, namely, a case where the entire surface of the negative electrode current collector layer was covered with the metal layer, the lithium secondary battery comprising the metal layer was not enhanced in capacity retention rate and short-circuit current as much as in the lithium secondary battery comprising the metal layer having a predetermined coverage.

It was presumed that the metal layer having a predetermined coverage promoted lithium nucleation, thereby allowing for suppression in generation of lithium dendrite. It was presumed that the entire surface of the negative electrode current collector layer was not covered with the metal layer serving as resistance, thereby enabling a favorable electron conductivity to be kept and thus resulting in an increase in capacity retention rate.

### Examples 5 to 21 (Influence of Second Metal Contained in Metal Layer)

### <Production of Preliminary Negative Electrode Laminate: Formation of Metal Layer on Negative Electrode Current Collector Layer>

Each preliminary negative electrode laminate was produced by the same method as in Example 1 except that each metal described in Table 2 was used as the first metal.

<Production of Lithium Secondary Battery, Evaluation of Capacity Retention Rate Thereof, Evaluation of Short-Circuit Current Thereof, and Evaluation of Discharged Capacity after Vibration Duration Thereof>

A lithium secondary battery was produced with the preliminary negative electrode laminate produced in each of Examples 5 to 21, by the same method as in Example 1. The capacity retention rate, the short-circuit current, and the discharged capacity after the duration test of the lithium secondary battery in each of Examples 5 to 21 were evaluated by the same methods as in Example 1. The respective results were as shown in Table 2.

TABLE 2

| | | | | | | Evaluation results | | |
|---|---|---|---|---|---|---|---|---|
| | | | | | | | | Discharged |
| | Negative | | | | | Capacity | | capacity |
| | electrode current | Metal layer | | | | retention | Short-circuit | after vibration |
| | collector layer | | | Thickness | Coverage | rate relative | current relative | duration relative |
| | Material of | | | of metal | with metal | to Comparative | to Comparative | to Comparative |
| | negative electrode | First | Second | layer | layer | Example 1 | Example 1 | Example 1 |
| | current collector | metal | metal | [nm] | [%] | [—] | [—] | [—] |
| Comparative | Copper (Cu) | — | — | — | — | 1.00 | 1.00 | 1.00 |
| Example 1 | | | | | | | | |
| Example 1 | Copper (Cu) | Tin (Sn) | Copper | 600 | 50 | 2.12 | 0.33 | 3.01 |
| | | | (Cu) | | | | | |
| Example 5 | Copper (Cu) | Magnesium | Copper | 600 | 60 | 2.11 | 0.39 | 3.04 |
| | | (Mg) | (Cu) | | | | | |
| Example 6 | Copper (Cu) | Aluminum | Copper | 600 | 70 | 2.14 | 0.38 | 3.05 |
| | | (Al) | (Cu) | | | | | |
| Example 7 | Copper (Cu) | Silicon | Copper | 600 | 80 | 2.03 | 0.38 | 3.02 |
| | | (Si) | (Cu) | | | | | |
| Example 8 | Copper (Cu) | Calcium | Copper | 600 | 95 | 2.15 | 0.32 | 3.17 |
| | | (Ca) | (Cu) | | | | | |
| Example 9 | Copper (Cu) | Scandium | Copper | 600 | 100 | 2.04 | 0.38 | 3.02 |
| | | (Sc) | (Cu) | | | | | |
| Example 10 | Copper (Cu) | Titanium | Copper | 600 | 60 | 2.14 | 0.37 | 3.11 |
| | | (Ti) | (Cu) | | | | | |
| Example 11 | Copper (Cu) | Manganese | Copper | 600 | 70 | 2.07 | 0.32 | 3.12 |
| | | (Mn) | (Cu) | | | | | |
| Example 12 | Copper (Cu) | Zinc (Zn) | Copper | 600 | 80 | 2.08 | 0.31 | 3.06 |
| | | | (Cu) | | | | | |
| Example 13 | Copper (Cu) | Gallium | Copper | 600 | 95 | 2.11 | 0.36 | 3.06 |
| | | (Ga) | (Cu) | | | | | |
| Example 14 | Copper (Cu) | Germanium | Copper | 600 | 100 | 2.04 | 0.38 | 3.07 |
| | | (Ge) | (Cu) | | | | | |
| Example 15 | Copper (Cu) | Strontium | Copper | 600 | 95 | 2.15 | 0.43 | 3.08 |
| | | (Sr) | (Cu) | | | | | |
| Example 16 | Copper (Cu) | Yttrium (Y) | Copper | 600 | 100 | 2.02 | 0.33 | 3.02 |
| | | | (Cu) | | | | | |
| Example 17 | Copper (Cu) | Zirconium | Copper | 600 | 60 | 2.13 | 0.32 | 3.02 |
| | | (Zr) | (Cu) | | | | | |
| Example 18 | Copper (Cu) | Palladium | Copper | 600 | 70 | 2.04 | 0.37 | 3.03 |
| | | (Pd) | (Cu) | | | | | |
| Example 19 | Copper (Cu) | Indium (In) | Copper | 600 | 80 | 2.02 | 0.30 | 3.11 |
| | | | (Cu) | | | | | |
| Example 20 | Copper (Cu) | Barium (Ba) | Copper | 600 | 95 | 2.14 | 0.37 | 3.02 |
| | | | (Cu) | | | | | |
| Example 21 | Copper (Cu) | Gold (Au) | Copper | 600 | 100 | 2.15 | 0.33 | 3.13 |
| | | | (Cu) | | | | | |

The lithium secondary battery comprising the metal layer containing other metal than Sn as the first metal was also increased in capacity retention rate and decreased in short-circuit current as compared with the lithium secondary battery comprising no metal layer. In addition, the lithium secondary battery comprising the metal layer was increased in discharged capacity after vibration duration. The short-circuit current was decreased, and it was thus indicated that generation of dendrite lithium was suppressed. Also in a case where various metals were contained in the first metal, it was presumed that the metal layer having a predetermined coverage promoted lithium nucleation, thereby allowing for suppression in generation of lithium dendrite. It was presumed that the entire surface of the negative electrode current collector layer was not covered with the metal layer serving as resistance, thereby enabling a favorable electron conductivity to be kept and thus resulting in an increase in capacity retention rate.

Although embodiments of the lithium secondary battery and the method for producing the lithium secondary battery of the present disclosure are described, it is understood by those skilled in the art that modifications can be made without departing from the claims.

### REFERENCE SIGNS LIST

100 Lithium secondary battery
100a Preliminary lithium secondary battery
110 Negative electrode laminate
110a Preliminary negative electrode laminate
111 Negative electrode current collector layer
112 Metal layer
113 Negative electrode active material layer
120 Electrolyte layer
130 Positive electrode laminate
131 Positive electrode active material layer
132 Positive electrode current collector layer

1. A lithium secondary battery, wherein
the lithium secondary battery comprises a negative electrode current collector layer, a metal layer, a negative electrode active material layer, an electrolyte layer, a positive electrode active material layer, and a positive electrode current collector layer in the listed order,
the negative electrode active material layer contains a lithium metal or a lithium alloy,
the coverage of the negative electrode current collector layer with the metal layer is 50% or more and less than 95%, and
the metal layer has a first metal that is taken with lithium to form an alloy, and a second metal contained in the negative electrode current collector layer.

2. The lithium secondary battery according to claim 1, wherein the thickness of the metal layer is 10 nm to 4000 nm.

3. The lithium secondary battery according to claim 1, wherein the first metal is at least one selected from magnesium, aluminum, silicon, calcium, scandium, titanium, manganese, zinc, gallium, germanium, strontium, yttrium, zirconium, palladium, indium, tin, barium, and gold.

4. A method for producing the lithium secondary battery according to claim 1, the method comprising the following steps of:
vapor-depositing the first metal and the second metal on a surface of the negative electrode current collector layer, thereby forming the metal layer, to obtain a preliminary negative electrode laminate,
stacking the preliminary negative electrode laminate, an electrolyte layer, a positive electrode active material layer that retains lithium, and a positive electrode current collector layer in the listed order, to obtain a preliminary lithium secondary battery, and
subjecting the preliminary lithium secondary battery to a charge operation, thereby depositing lithium transferred from the positive electrode active material layer, on a surface of the metal layer, to form the negative electrode active material layer and thus obtain the lithium secondary battery.
